(19) United States
(12) Patent Application Publication
(10) Pub. No.: US 2023/0417098 A1
(43) Pub. Date: Dec. 28, 2023

(54) Control and display device for the movement of a vertically sliding roller door

(71) Applicant: BMPEUROPE S.r.l., VILLANOVA d'ASTI (AT) (IT)

(72) Inventor: Danilo BENOTTO, Montá (CN) (IT)

(21) Appl. No.: 18/206,480

(22) Filed: Jun. 6, 2023

(30) Foreign Application Priority Data
Jun. 8, 2022 (IT) 102022000012134

(51) Int. Cl. E05F 15/668; G08B 5/38

(52) U.S. Cl. CPC E05F 15/668; G08B 5/38; E05Y 2400/52; E05Y 2400/66

(57) ABSTRACT

A device for controlling movement of a vertically sliding roller shutter door including a portal structure with uprights having guide rails for sliding a roller shutter for closing the door and a shelter zone for the roller shutter in the open condition delimited by an upper crosspiece, comprises motorized controllers for controlling movement of the roller shutter which are controlled by at least one operating member that generates an actuating signal for the motorized controller. The operating member includes an emitter indicative of an instantaneous setting of the roller shutter, and the device comprises a control unit connected to the operating member, to the emitter of signals of the operating members, to the motorized controller and to detector of the instantaneous attitude of the rolling shutter, to actuate the motorized controller and to emit a signal correlated with the instantaneous attitude of the roller shutter through the operating member.

### FIELD OF THE INVENTION

The present invention generally refers to vertically sliding doors for industrial use, in which opening and closing of a passage formed in a wall and delimited by a portal structure takes place with a relatively high speed.

### SUMMARY OF THE INVENTION

More specifically, the invention refers to a vertically sliding roller door comprising a portal structure which defines a pair of opposing vertical guide rails for guiding the sliding of lateral edges of a roller shutter for closing the door, for the purpose of allowing vertical upward and downward movements of the roller shutter with respect to the portal structure, a shelter area for the roller shutter wound up in the open condition of the door being defined above the portal structure.

More specifically, the invention relates to a device for controlling and displaying the movement of a rapidly vertically sliding roll-up door as defined in the preamble of the annexed claim 1, for the purpose of making access by a user through such a door easier and more immediate. In fact, especially in the case of vertically sliding roller doors with a high extension in height, it can be impractical and sometimes difficult for a user at ground level to monitor the variations in the position of the roller shutter before or during crossing it, since there is the risk that the user may be at the portal structure when the roller shutter is about to start a movement step, particularly a descent step.

The main object of the present invention is to propose a rapid vertical sliding roller shutter door which is provided with a device for controlling the attitude of the roller shutter, particularly during the steps of ascent, of standing in the open condition, and of descent, provided with at least an operating member which allows the instantaneous attitude of the roller shutter to be displayed promptly and clearly to inform a user if it is moving, in which case the crossing of the portal structure is precluded, or if the roller shutter is in the open and stationary configuration, in which case the portal structure can be crossed freely.

This object is achieved by the invention by virtue of the fact that said at least one operating member incorporates means for emitting signals indicative of an instantaneous attitude of the roller shutter, and of the fact that the device comprises an electronic control unit connected to said at least one operating member, to the means for emitting signals of each operating member, to said motorized means and to means for detecting an instantaneous attitude of the rolling shutter, for the purpose of activating said motorized means and of emitting a signal indicative of an instantaneous attitude of the shutter through said at least one operating member.

By virtue of these features, the device of the invention makes it possible to control the operation of the sliding door and to immediately display the attitude condition of the roller shutter to allow a user to cross the portal structure free of the roller shutter in complete safety.

According to a preferred feature of the invention, each operating member consists of a push-button switch of the normally open type. In this manner, the operating member or members of the device of the invention has or have a simple and inexpensive structure, and they are easily available on the market, to the full advantage of the cheapness of the device.

According to another preferred feature of the invention, said at least one operating member has an outer covering of a transparent or semi-transparent material, and said means for emitting signals indicative of an instantaneous attitude of the roller shutter consist of at least one light emitting element incorporated in each operating member.

In this manner, the device of the invention allows a user to be visually informed of the instantaneous configuration of the roller shutter.

According to yet another preferred feature of the invention, said at least one operating member comprises a pair of emitting elements of light having different wavelengths, which are intended to be operated individually and separately for different attitude conditions of the roller shutter, a first light emitting element being able to be activated during a vertical movement of the roller shutter, and a second light emitting element being able to be activated when the roller shutter is in its raised stationary configuration. This makes it possible to effectively and immediately display an instantaneous condition of the attitude of the roller shutter.

### BRIEF DESCRIPTION OF THE DRAWINGS

Further characteristics and advantages of the invention will become clearer from the following detailed description provided by way of non-limiting example and referred to the attached drawings in which:

FIG. 1 is a schematic perspective view of a high-speed roller shutter door in its closed condition dorresponding to the fully lowered configuration of the roller shutter, in which the device of the invention, can be activated,

FIG. 2 is a view similar to FIG. 1, in which the roller shutter begins an ascent movement as a result of the activation of the device of the invention,

FIG. 3 is a view similar to FIG. 2 with the roller shutter in the fully raised configuration, in which passing through the portal structure of the sliding door is permitted,

FIG. 4 is a view similar to FIG. 3, in which the roller shutter is animated by a downward movement, and

FIG. 5 is a diagrammatic view schematically showing the main elements of the device of the invention.

### DETAILED DESCRIPTION OF THE INVENTION

With reference to the drawings, a roll-up door, indicated as a whole by the reference numeral 10, comprises a portal structure 12 associated with a generally rectangular passage opening 14 formed in a wall of a building. The opening 14, which is delimited sideways by a pair of vertical and parallel uprights 16 and, in the vertical direction, by an upper crosspiece 18 and by a lower base plane 19, can be closed by means of a roller shutter 20 which can consist of a flexible curtain of plastic material such as PVC, polyethylene or polyurethane, or of a plasticized textile material, usually having a thickness of the order of a millimeter or a few millimeters, or of a roller shutter consisting of a series of elongated panels or slats arranged perpendicularly to the uprights 16 and articulated with each other. The side edges of the roller shutter 20 slidably engage guide rails 24 formed along the uprights 16, whereby the roller shutter 20 is movable between a closed configuration, or lowered relative to the lower plane 19, in which it closes the opening 14, and an open configuration, or raised with respect to the lower surface 19, in which the opening 14 is free.

Above the crosspiece 18 of the portal structure 12 there is a shelter area 22 for the rolling shutter 20, for example in its configuration wrapped around a central shaft (not shown in the drawings as it is of a known per se type) parallel to the crosspiece 18 and mounted rotatably about its own axis, which constitutes driving means of the roller shutter 20, or according to a spirally wound configuration with its lateral edges slidingly engaged in spiral-shaped guide grooves (not shown) that extends from the top of the guide rails 24, in which case the roller shutter 20 is operated by driving means in the form of toothed wheels which engage areas adjacent to its lateral edges, the rotation of which drags the roller shutter 20 by friction.

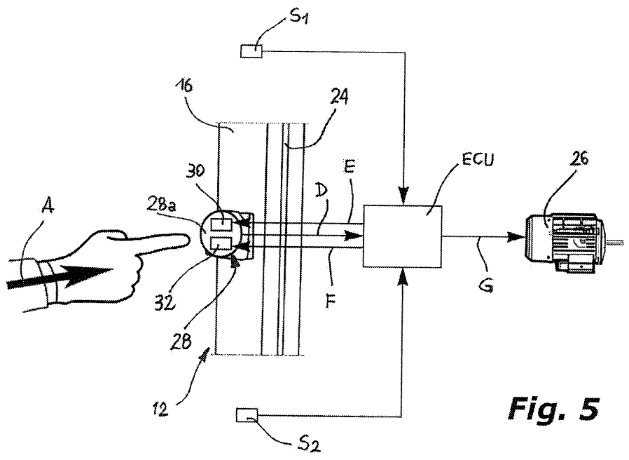

In both the cases mentioned above, the movement of the roller shutter 20 takes place due to the aforesaid driving means which are controlled by motorized means including an electric motor 26 (shown schematically in FIG. 5), usually supported directly by the portal structure 12 and incorporated in the shelter area 22.

The motor 26 is operated by at least one operating member 28 having a movable part, consisting of a spring-loaded button switch of the normally open type, i.e. of the type capable of closing a circuit as a result of its compression, arranged on an upright 16. The operating member 28 is able to generate, as a result of its manual actuation, an activation signal for the engine 26 through an electronic control unit ECU which will be referred to in greater detail below.

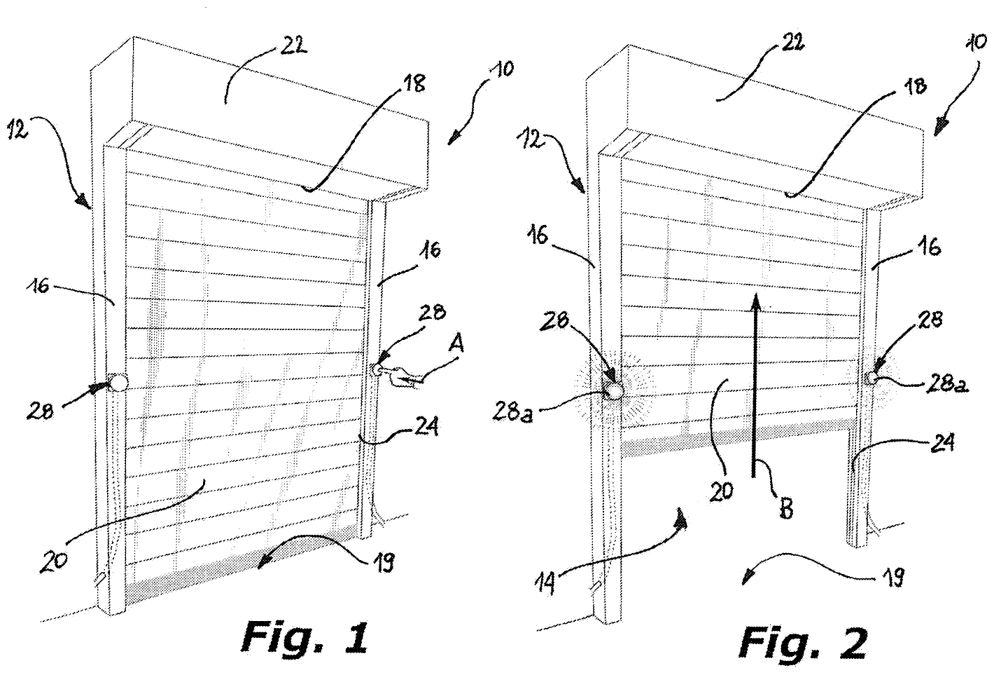

Preferably, and as shown in FIGS. 1 to 4, the device of the invention comprises two identical operating members 28, each arranged at the same front side of a respective upright 16 of the structure 12.

Each operating member 28 is provided with an outer covering 28a of a transparent or semi-transparent material, and incorporates at least one light emitting element intended to light up as a result of its compression. In particular, the aforementioned light emitting element lights up as a result of the detection of a particular operating condition of the roller shutter 20, such as a state of movement or stop of the roller shutter 20 in the open condition, for the purpose of signaling to a user the possibility of crossing the opening 14 of the portal structure 12.

The electronic control unit ECU is connected to each operating member 28 so as to receive from at least one of them a signal generated by the compression thereof, to the electric motor 26 for controlling its actuation according to one direction of rotation or another, and to at least one light emitting element incorporated in the respective operating member 28, which will be referred to in greater detail below. The ECU unit is capable of activating the at least one light emitting element of each operating member 28 as a function of the detection of the instantaneous attitude condition of the rolling shutter 20.

This instantaneous attitude condition of the roller shutter 20 can be ascertained by means of detection means of the attitude of the roller shutter 20 connected to the control unit ECU, represented schematically and by way of example in FIG. 5 by means of a pair of position sensors indicated generically S₁, S₂, respectively upper and lower, capable of signaling the achievement of the upper and lower end-of-stroke configurations, i.e. of opening and closing, of the roller shutter 20 with respect to the portal structure 12. As an alternative, the sensor means can consist of one or more sensors incorporated in the motor 26 and adapted to recognize, upon reaching one of the aforementioned end-of-stroke configurations, the occurrence of a resistance against a further rotation of the motor 26, or of a single sensor capable of detecting an upper or lower stop of the movement of the rolling shutter 20.

Each operating member 28 preferably contains two separate light emitting elements, respectively indicated by reference numerals 30 and 32, each of which conveniently consists of a LED, the emitting elements 30 and 32 being able to emit light having a different wavelength and intended to be actuated individually in response to different attitude conditions of the roller shutter 20 identified by the means for detecting the instantaneous attitude of the roller shutter 20 referred to above. The light emitting elements 30 and 32 allow a light signal correlated with the relative instantaneous condition of the rolling shutter 20 to be displayed at each operating member 28.

In particular, the first light emitting element 30 is activated by the ECU unit when the roller shutter 20 is subject to a vertical upward or downward movement, while the second light emitting element 32, is activated when the roller shutter 20 is in the fully raised and stationary condition, i.e. when the roll-up door 10 is in its open configuration.

Preferably, the first light emitting element 30 is a LED which emits a visible red light, conveniently according to a flashing mode, to signal that the roller shutter 20 is moving and that it is not allowed to pass through the opening 14 of the portal structure 12. Still preferably, the second light emitting element 32 is a LED which emits a continuous visible green or blue light to signal that the roller shutter 20 is in the fully raised configuration in which it is allowed to pass through the opening 14 of the portal structure 12.

In the operation of the device of the invention, starting from the closed configuration of the roller shutter door 10 shown in FIG. 1 in which the roller shutter 20 is in the fully lowered condition with its lower end portion or slat in contact with the lower base plane 19, both the light emitting elements 30 and 32 being inactive and switched off, a user subjects an operating member 28 to a compression by manual action, for example by means of a finger, in the direction indicated by arrow A of FIGS. 1 and 5.

The compression applied to the operating member 28 generates an electric impulse which is transmitted to the unit ECU according to the direction of arrow D of FIG. 5; this impulse causes the emission of a signal by the unit ECU according to the arrow G, which controls the operation of the electric motor 26 to cause, in the considered situation, an upward movement of the roller shutter 20 along the direction indicated by arrow B of FIG. 2.

The unit ECU simultaneously receives via the sensor means S₁, S₂, an information relating to the instantaneous attitude of the roller shutter 20, which in this case is subject to an upward movement, and activates the first light emitting element 30 of both the operating elements 28 via a signal identified by the arrow E of FIG. 5. The elements 30 emit a visual signaling through the transparent or semi-transparent covering 28a of the operating elements 28, which preferably consists of a flashing red light, outlined, in FIG. 2 by a series of radial dotted lines extending from the members 28, to provide the signaling that, since the roller shutter 20 is moving, crossing the opening 14 of the structure 12 is not allowed.

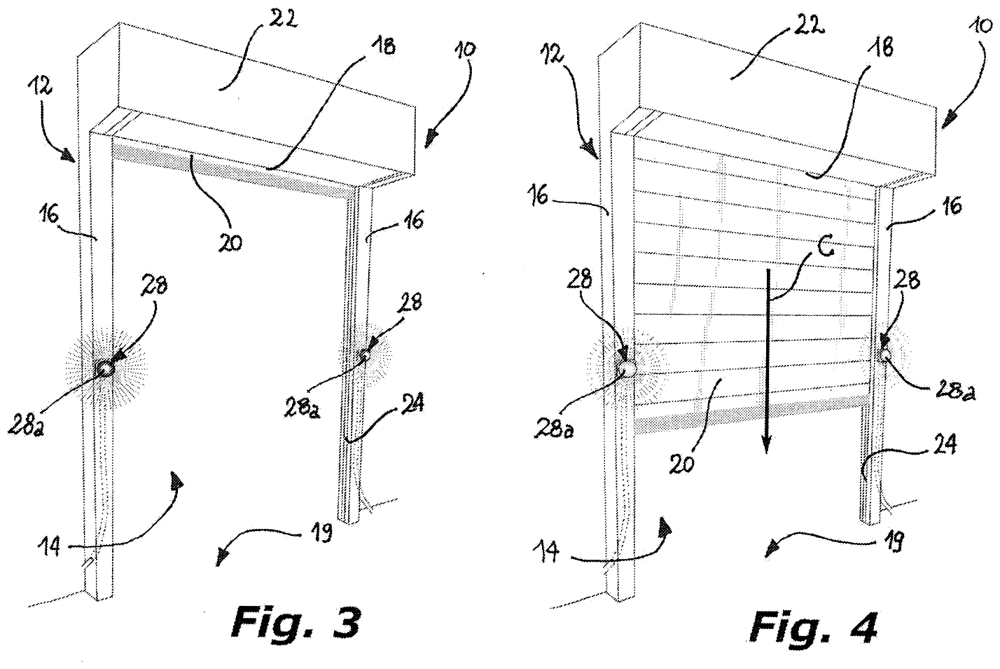

At the end of the raising step of the roller shutter 20, shown in FIG. 3, the sensor means S₁, S₂ signal to the unit ECU that the roller shutter 20 has reached its raised configuration, and the same unit ECU emits a signal indicated by arrow G of FIG. 5 to stop the engine 26. Simultaneously, the unit ECU, informed by the sensor means S₁, S₂ of the fact that the roller shutter 20 is in its raised and stationary configuration, deactivates the first light emitting element 30 of the members 28 through a signal directed according to the arrow E of FIG. 5, and emits a signal indicated by arrow F of the same Figure to activate the second light emitting element 32 of the members 28.

The second emitting elements 32 emit, through their own transparent or semi-transparent covering 28a, a visual signaling which preferably consists of a continuous green or blue light, schematically represented in FIG. 3 by a series of continuous rays coming from the members 28, to provide the signaling that, since the roller shutter 20 is in its raised stationary configuration, crossing of the opening 14 of the structure 12 is allowed.

The duration of the opening step of the rolling shutter 20 can be set as desired by means of a timer unit (not shown) of the unit ECU and can normally last for a time varying between 5 and 15 s.

At the end of the duration set in the timer unit of the unit ECU for the stationary and raised step of the rolling shutter 20, the unit ECU emits an actuation impulse towards the motor 26, as indicated by arrow G of FIG. 5, according to a direction of rotation opposite to the upward rotation of the roller shutter 20, causing a movement of the roller shutter 20 in the direction indicated by arrow C of FIG. 4.

Simultaneously, the sensor means S₁, S₂ inform the unit ECU that the roller shutter 20 is moving, whereby the unit ECU deactivates the second light emitting elements 32 of the members 28 and emits a signal indicated by arrow E of FIG. 5 to activate the first light emitting elements 30 again, to emit the visual signaling which preferably consists of a flashing red light outlined in FIG. 4 with a series of dashed rays, so as to inform a user that crossing the opening 14 of the portal structure 12 is not allowed since the rolling shutter 20 is moving.

When the roller shutter 20, at the end of the descent step, reaches the completely lowered configuration represented in FIG. 1, the ECU unit emits a signal to the motor 26 to stop it and simultaneously deactivates the light emitting element 30, so that the switching members 28 are turned off.

1. A control device for controlling and displaying the movement of a rapid vertical sliding roll-up door, which door comprises a portal structure including a pair of uprights which define respective opposite guide rails to guide the sliding of opposite lateral edges of a roller shutter for closing the door, and an upper crosspiece delimiting a shelter area for the roller shutter in the open condition of the door, the movement of the roller shutter with respect to said portal structure being controlled by a motorized controller of the movement of the roller shutter, which can be controlled by at least one movable operating member adapted to generate an activation signal of said motorized controller,
wherein said at least one operating member incorporates an emitter for emitting signals indicative of an instantaneous attitude of the roller shutter, and the device comprises an electronic control unit connected to said at least one operating member, to the emitter for emitting signals of each operating member, to said motorized controller and a detector for detecting of an instantaneous attitude of the roller shutter, for the purpose of activating in order to drive said motorized controller and to emit a signal indicative of an instantaneous attitude of the roller shutter through said at least one operating member.

2: The control device according to claim 1, wherein each operating member consists of a push button switch of the normally open type.

3: The control device according to claim 1, wherein said at least one operating member has an outer covering of a transparent or semi-transparent material, and said emitter for emitting signals indicative of an instantaneous attitude of the roller shutter consist of at least one light emitting element incorporated in each operating member.

4: The control device according to claim 3, wherein said at least one operating member comprises a pair of emitting elements of light having different wavelengths, which are configured to be operated individually and separately for different attitude conditions of the roller shutter, a first light emitting element being able to be activated during a vertical movement of the roller shutter, and a second light emitting element being able to be activated when the roller shutter is in its stationary raised configuration.

5: The control device according to claim 4, wherein said a least one operating member comprises a first light emitting element configured to be operated during a vertical movement of the roller shutter, and a second light emitting element configured to be operated when the roller shutter is in its stationary raised configuration.

6: The control device according to claim 5, wherein the first light emitting element is activated according to a flashing mode.

7: The control device according to claim 1, wherein said motorized controllers have an electric motor associate with a dragger for dragging the roller shutter in the form of a rotating shaft that extends into said shelter area of the roller shutter parallel to the upper crosspiece of the portal structure, or in the form of friction dragging the roller shutter adapted for engaging areas of the roller shutter adjacent to its lateral edges which engage, in said shelter area, spiral-shaped guide grooves connected to the guide rails of the uprights of the portal structure.

8: The control device according to claim 1, wherein the at least one operating member comprises a pair of operating members, each of the pair of operating members arranged on a respective upright of the portal structure.

9: The control device according to claim 1, wherein the electronic control unit comprises a timer unit for setting the duration of the open configuration of the roller shutter.

10: The control device according to claim 5, wherein the first light emitting element is red in color.

11: The control device according to claim 5, wherein the second light emitting element is green or blue in color.
